(19) United States
(12) Patent Application Publication
(10) Pub. No.: US 2025/0028123 A1
(43) Pub. Date: Jan. 23, 2025

(54) OPTICAL FIBER CONNECTOR, OPTICAL FIBER ADAPTER, AND OPTICAL FIBER CONNECTION SYSTEM

(71) Applicant: Senko Advanced Components Inc., Hudson, MA (US)

(72) Inventors: Mingzhen HU, Shanghai (CN); Kazuyoshi TAKANO, Tokyo (JP); Man Kit Wong, Hong Kong (CN)

(73) Assignee: Senko Advanced Components Inc., Hudson, MA (US)

(21) Appl. No.: 18/715,276

(22) PCT Filed: Dec. 1, 2022
(86) PCT No.: PCT/CN2022/135864

§ 371 Date: May 31, 2024

(30) Foreign Application Priority Data
Dec. 2, 2021 (CN) 202111473781.2
Sep. 2, 2022 (CN) 202211074111.8

(51) Int. Cl. G02B 6/38

(52) U.S. Cl. CPC G02B 6/3825; G02B 6/3849; G02B 6/3893

(57) ABSTRACT

An optical fiber connector, an optical fiber adapter and an optical fiber connection system. The optical fiber connector (110) is configured to be mated with the optical fiber adapter (160). The optical fiber connector (110) includes an inner housing (111), a ferrule assembly (121), a rear body (122), an elastic member (133), and a sealing component (134). The sealing component (134) is clamped between the inner housing (111) and the rear body (122). The optical fiber adapter is configured to receive the optical fiber coupler. The optical fiber connection system includes the above-mentioned optical fiber connector and the optical fiber adapter.

### CROSS REFERENCE

This application claims the benefit of the Chinese patent application No. 202111473781.2 on Dec. 2, 2021, entitled “Optical Fiber Connector, Optical Fiber Adapter, and Optical Fiber Connection System”, and the Chinese patent application No. 202211074111.8 on Sep. 2, 2022, entitled “An Optical Fiber Connector, Optical Fiber Adapter, and Optical Fiber Connection System”, which are incorporated herein by reference in their entirety.

### BACKGROUND

The present application generally relates to the technical field of optical fiber connectors, and in particular to an optical fiber connector, an optical fiber adapter and an optical fiber connection system.

Current optical fiber connectors and adapters are not waterproof, and liquid may enter a device through the optical fiber connector or adapter, causing damage to the device.

Therefore, there is a need for an optical fiber connector, an optical fiber adapter and an optical fiber connection system to at least partially solve the above problems.

### SUMMARY

A series of simplified concepts are introduced into the SUMMARY of the present application, and would be further illustrated in the DETAILED DESCRIPTION. The Summary of the present application does not mean to define the key and essential technical features of the claimed technical solution, let alone determining the protection scope thereof.

To at least partially solve the problem, a first aspect of the present application provides an optical fiber connector for mating with an optical fiber adapter comprising:
an inner housing comprising a front end portion, a rear end portion, and an open space extending from the front end portion to the rear end portion, the front end portion used to be inserted into the optical fiber adapter, and the rear end portion provided with a first engaging portion;
a ferrule assembly disposed in the open space of the inner housing and used to accommodate optical fiber(s), and at least partially exposed from the front end portion;
a rear body connected to the rear end portion of the inner housing and having a first matching portion configured to form a snap fit with the first engaging portion;
an elastic member disposed in the open space and held between the ferrule assembly and the rear body; and
a sealing component held between the inner housing and the rear body.

A second aspect of the present application provides an optical fiber adapter comprising two oppositely disposed receiving portions, a partition wall is arranged between the two receiving portions, the receiving portions comprise a first receiving portion for receiving a first optical fiber connector, and the first receiving portion comprises:
a first housing having a first insertion end, a first mating end, and a first passage extending from the first insertion end to the first mating end, and the first insertion end of the first housing being provided with a keyway opening for receiving a key portion of the first optical fiber connector;
a first sealing member disposed at the first mating end and attached to the partition wall;
a hook element disposed in the first housing and configured to press the first sealing member onto the partition wall, and the hook element having an accommodating space for accommodating at least part of the optical fiber connector.

A third aspect of the present application provides an optical fiber connection system comprising:
at least one first optical fiber connector configured as the optical fiber connector of the first aspect; and
the optical fiber adapter of the second aspect;
wherein the first optical fiber connector is insertable into a first receiving portion of the optical fiber adapter and is capable of pressing a first sealing member located in a first housing of the first receiving portion for a watertight sealing.

A fourth aspect of the present application provides an optical fiber connector comprising:
an outer housing;
an inner housing accommodated in the outer housing and comprising a snap-fit structure for receiving a hook element of a mating optical fiber adapter;
a ferrule assembly disposed in the inner housing;
a rear body connected to the inner housing; and
a sealing component disposed between the inner housing and the rear body.

The optical fiber connector according to the present application is waterproof by providing a sealing component, preventing moisture from entering the interior of the device through the connector.

Optionally, the outer housing is configured to be movable relative to the inner housing.

The optical fiber connector according to the present application has inner and outer housings, and the two housings are movable relative to each other.

Optionally, the outer housing includes at least one elastic portion, and the optical fiber connector is configured to move under the biasing action of the at least one elastic portion.

According to the optical fiber connector of the present application, the outer housing may move back and forth axially relative to the inner housing, so that the outer housing may cover or expose the snap-fit structure of the inner housing.

Optionally, the snap-fit structure includes a slope to facilitate the mating of the optical fiber connector to the optical fiber adapter.

According to the optical fiber connector of the present application, during the mating process with the adapter, a slope structure is used to make the corresponding part of the adapter engage or disengage from the snap-fit structure.

Optionally, the rear body is connected to the inner housing by threads.

According to the optical fiber connector of the present application, the connection between the rear body and the inner housing is simple and easy to implement.

Optionally, the optical fiber connector further includes an elastic member and a stopper, wherein the clastic member and the stopper are arranged in the inner housing, and the elastic member is located between the ferrule assembly and the stopper, such that the ferrule assembly is exposed from the front end of the inner housing, and the stopper abuts against the sealing component at the rear end of the inner housing.

According to the optical fiber connector of the present application, the ferrule assembly is exposed from the front end of the inner housing by using the elastic member and the stopper.

Optionally, the rear body includes a rear body head end threaded to the inner housing and a rear body tail end.

The optical fiber connector also includes a crimp ring connected to the rear body tail end and including fixing teeth for securing a sheath of an optical fiber core to the rear body tail end.

The optical fiber connector according to the present application secures the sheath of the optical fiber core to the rear body by using the crimp ring having the fixing teeth.

Optionally, the sealing component is configured to include the form of steps.

According to the optical fiber connector of the present application, the sealing component is configured in the form of steps, and the thickness of the middle portion of the sealing component is greater than that of the edge portion thereof, which can effectively improve the waterproof performance of the sealing component.

Optionally, the optical fiber connector includes an MPO connector.

A fifth aspect of the present application provides an optical fiber adapter comprising:
an adapter housing comprising a first receiving portion and a second receiving portion opposite the first receiving portion and defining a passage extending therebetween, a partition wall being provided in the passage and dividing the passage into a first passage and a second passage communicating with the first passage;
at least one first sealing member disposed in at least one of the first passage and the second passage and engaged to the partition wall; and
at least one hook element disposed in at least one of the first passage and the second passage and abutting the first sealing member against the partition wall, and the hook element including an accommodating space for accommodating an optical fiber connector,
wherein the hook element includes a side arm configured to lock the optical fiber connector when the optical fiber connector is inserted into the optical fiber adapter.

The optical fiber adapter according to the present application can prevent moisture from entering the interior of the device by providing a first sealing member in the adapter.

Optionally, the hook element includes a locking portion to connect the hook element to the adapter housing.

According to the optical fiber adapter of the present application, the hook element is secured to the adapter housing through the locking portion.

Optionally, the optical fiber adapter further includes a second sealing member disposed between the first receiving portion and the second receiving portion.

The optical fiber adapter according to the present application further improves the waterproof performance by the second sealing member.

Optionally, the adapter housing further includes a receiving groove for receiving the second sealing member,
wherein the optical fiber adapter is configured such that when the optical fiber adapter is mounted to a device, the second sealing member is located between the adapter housing and an outer surface of the device.

According to the optical fiber adapter of the present application, the second sealing member is used to be closely attached to the outer surface of the device, such that the opening of the outer surface of the device may be waterproof.

Optionally, the side arm is provided with a hook portion.

According to the optical fiber adapter of the present application, the hook portion of the side arm of the hook element is used to lock the connector.

Optionally, the first sealing member is configured in the form of steps.

According to the optical fiber adapter of the present application, the first sealing member is configured in the form of steps, and the thickness of the middle portion of the first sealing member is greater than that of the edge portion thereof, which can effectively improve the waterproof performance of the first sealing member.

Optionally, the hook element contacts an edge portion of the first sealing member, abutting the first sealing member against the partition wall.

According to the optical fiber adapter of the present application, the first sealing member is firmly secured in the adapter housing by the hook element.

Optionally, the optical fiber adapter includes an MPO type adapter.

A sixth aspect of the present application provides an optical fiber connection system comprising the above-mentioned optical fiber connector according to the fourth aspect of the present application and the above-mentioned optical fiber adapter according to the fifth aspect of the present application, wherein the inner housing is configured such that when the optical fiber connector is mated with the optical fiber adapter, the inner housing presses the at least one first sealing member, forming an environmental seal and preventing moisture and impurities from entering.

According to the optical fiber connection system of the present application, by providing waterproof components in the connector and the adapter respectively, when the connector is connected to the adapter, the inner housing of the connector abuts against the waterproof components at the front and rear ends respectively, so that the connection openings between the device and the external environment are sealed with waterproof components to effectively prevent moisture from entering the interior of the device.

Optionally, the first sealing member is configured in the form of steps, and the thickness of the middle portion of the first sealing member is greater than that of the edge portion thereof.

The optical fiber connection system is configured such that when the optical fiber connector is inserted into the optical fiber adapter, the front end of the inner housing abuts against the middle portion of the first sealing member.

According to the optical fiber connection system of the present application, the middle portion of the first sealing member of the adapter is configured to protrude toward the connector to better contact the connector.

Optionally, the optical fiber connector further includes an outer housing disposed around the inner housing and being movable relative to the inner housing, and the optical fiber connection system is configured such that:
when the optical fiber connector is inserted into the optical fiber adapter, the side arm pushes the outer housing toward the rear end of the inner housing; and/or
after the optical fiber connector is inserted into the optical fiber adapter, the outer housing extends into the passage and is located outside the hook element.

According to the optical fiber connection system of the present application, when the optical fiber connector is inserted into the optical fiber adapter, the adapter may push the outer housing backward, exposing the snap-fit structure on the inner housing to facilitate the mating of the adapter with the connector. After the optical fiber connector is inserted into the optical fiber adapter, the hook element of the adapter is sandwiched between the two housings of the connector, such that the connector and the adapter are securely connected.

### BRIEF DESCRIPTION OF THE DRAWINGS

The following drawings are incorporated herein as part of the present application for the understanding of the present application. The embodiments of the present application are illustrated and described in the drawings in order to explain the principles of the present application.

In the drawings:

FIG. 1 is a perspective schematic view of an optical fiber connector according to a first preferred embodiment of the present application;

FIG. 2 is an exploded schematic view of the optical fiber connector in FIG. 1;

FIG. 3 is a perspective schematic view of an inner housing in FIG. 2;

FIG. 4 is a perspective schematic view of a rear body in FIG. 2;

FIG. 5 is a perspective schematic view of an outer housing in FIG. 2;

FIG. 6 is a schematic view of a first step of the assembly process of the optical fiber connector according to the first preferred embodiment of the present application;

FIG. 7 is a schematic view of a second step of the assembly process of the optical fiber connector according to the first preferred embodiment of the present application;

FIG. 8 is a schematic view of a third step of the assembly process of the optical fiber connector according to the first preferred embodiment of the present application;

FIG. 9 is a sectional schematic view of the optical fiber connector along A-A′ direction in FIG. 1;

FIG. 10 is a sectional schematic view of the optical fiber connector along B-B′ direction in FIG. 9;

FIG. 11 is a perspective schematic view of an optical fiber adapter according to a second preferred embodiment of the present application;

FIG. 12 is an exploded schematic view of the optical fiber adapter in FIG. 11;

FIG. 13 is a perspective schematic view of a hook element in FIG. 12;

FIG. 14 is a sectional schematic view of the optical fiber adapter in FIG. 11;

FIG. 15 is a schematic view of an installation process of an optical fiber connection system according to a third preferred embodiment of the present application;

FIG. 16 is a perspective schematic view of the optical fiber connection system according to the third preferred embodiment of the present application;

FIG. 17 is a partially enlarged schematic view of the connection between the optical fiber connector according to the first preferred embodiment of the present application and the optical fiber adapter according to the second preferred embodiment of the present application;

FIG. 18 is a sectional schematic view of the optical fiber connection system in FIG. 16;

FIG. 19 is an exploded schematic view of an optical fiber adapter according to a fourth preferred embodiment of the present application;

FIG. 20 is a sectional schematic view of the optical fiber adapter according to the fourth preferred embodiment of the present application;

FIG. 21 is a schematic view of an installation process of an optical fiber connection system according to a fifth preferred embodiment of the present application;

FIG. 22 is a perspective schematic view of the optical fiber connection system according to the fifth preferred embodiment of the present application;

FIG. 23 is a sectional schematic view of the optical fiber connection system in FIG. 22;

FIG. 24 is a perspective view of an optical fiber connector according to a sixth preferred embodiment of the present application;

FIG. 25 is a perspective view of an optical fiber adapter according to a seventh preferred embodiment of the present application;

FIG. 26 is a perspective view of an optical fiber connection system according to an eighth preferred embodiment of the present application;

FIG. 27 is an exploded perspective view of the optical fiber connector shown in FIG. 24;

FIG. 28 is a perspective view of an outer housing of the optical fiber connector according to the sixth preferred embodiment of the present application;

FIG. 29 is a perspective view of an inner housing of the optical fiber connector according to the sixth preferred embodiment of the present application;

FIG. 30 is an axial sectional view after the outer housing shown in FIG. 28 is connected to the inner housing shown in FIG. 29;

FIG. 31 is an axial sectional view of the optical fiber connector shown in FIG. 24;

FIG. 32 is an exploded perspective view of the optical fiber adapter according to the seventh preferred embodiment of the present application;

FIG. 33 is a perspective view of an adapter housing of the optical fiber adapter according to the seventh preferred embodiment of the present application;

FIG. 34 is an axial sectional view according to the seventh preferred embodiment of the present application;

FIG. 35 is a perspective view of a first sealing member of the optical fiber adapter according to the seventh preferred embodiment of the present application;

FIG. 36 is a perspective view of a hook element of the optical fiber adapter according to the seventh preferred embodiment of the present application; and

FIGS. 37 to 39 show the connection of the optical fiber connector of the sixth preferred embodiment and the optical fiber adapter of the seventh preferred embodiment.

### DETAILED DESCRIPTION

In the following description, numerous specific details are set forth in order to provide a more thorough understanding of the present application. However, it is obvious to those skilled in the art that the present application may be implemented without one or more of these details. Some technical features well-known in the art are not described in other examples in order to avoid confusion with the present application.

It shall be noted that the terminology used herein is for the purpose of describing particular embodiments only and is not intended to limit the exemplary embodiments of the present application. As used herein, the singular form is intended to include the plural form as well, unless the context clearly indicates otherwise. It should be further understood that the terms “comprising” and/or “including,” when used in this specification, specify the presence of stated features, wholes, steps, operations, elements, and/or components, but do not exclude the presence or addition of one or more other features, wholes, steps, operations, elements, components, and/or combinations thereof.

Ordinals such as “first” and “second” quoted in this application are merely identifiers and do not have any other meaning, such as a specific order. Moreover, for example, the term “first component” itself does not imply the presence of “second component”, and the term “second component” itself does not imply the presence of “first component.” It should be noted that the terms “up”, “down”, “front”, “back”, “left”, “right”, “inside”, “outside” and similar expressions used herein are for illustrative purposes only and are not restrictive.

The exemplary embodiments of the present application will be explained in further details with reference to the accompanying drawings.

As used herein, the term “optical fiber” is intended to apply to all types of single-mode and multimode optical waveguides, including one or more bare optical fibers, coated optical fibers, loose-tube optical fibers, tight-buffered optical fibers, ribbon optical fibers, bend-performance optical fibers, bend-insensitive optical fibers, nano-structured optical fibers, or any other means for transmitting optical signals. Multi-fiber cables include multiple optical fibers that may be arranged within a single connector. For example, a multi-fiber connector using multi-fiber push/pull (MPO) technology may include and connect 12 or 24 optical fibers. Although the following description is directed to MPO adapters and MPO connectors, the described embodiments are also applicable to other types of connectors and ferrule types.

### First Preferred Embodiment

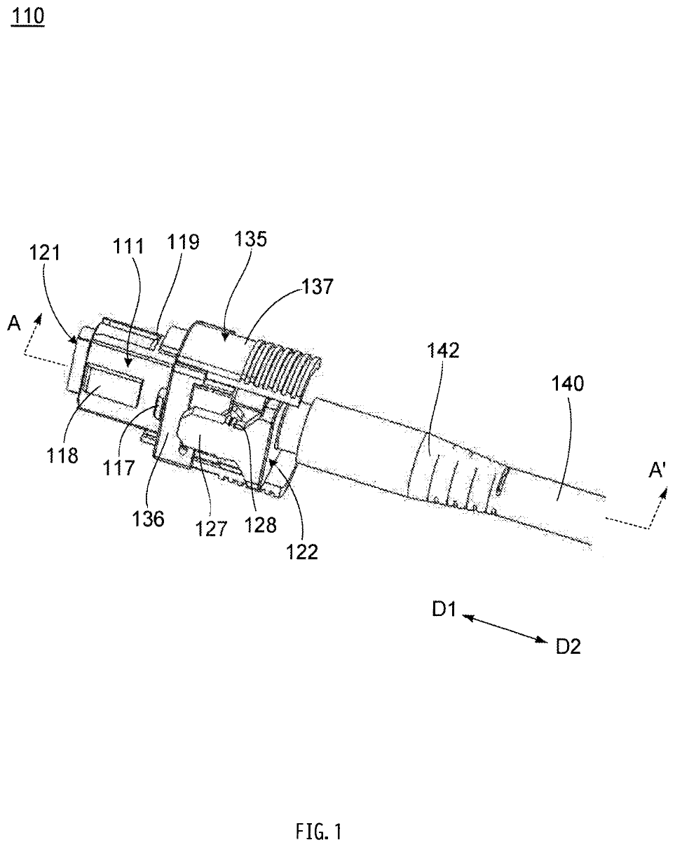

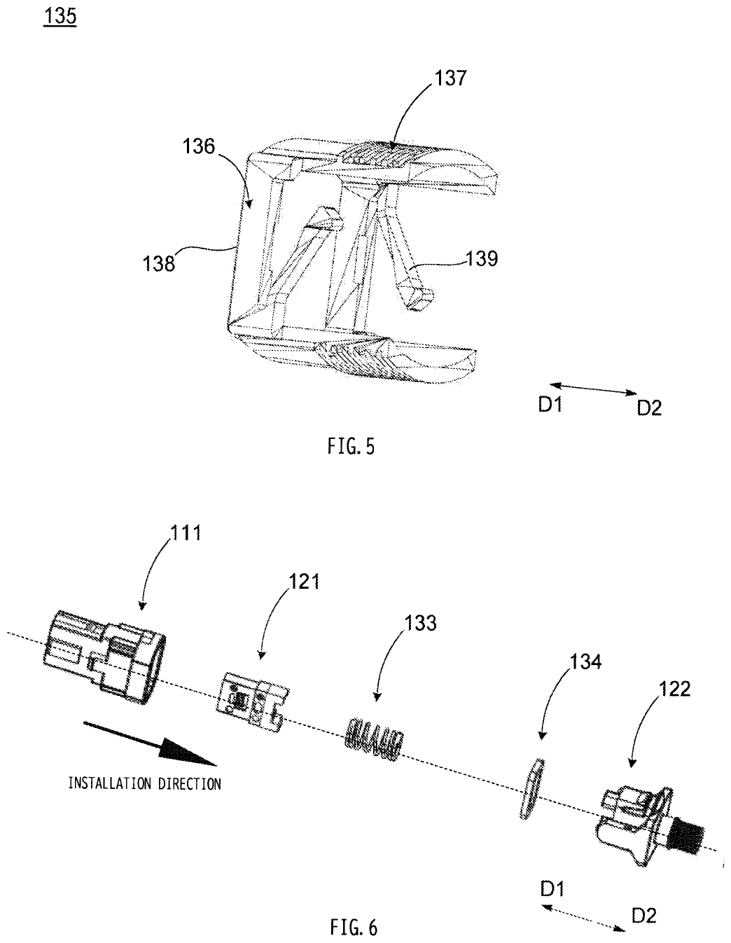

The first preferred embodiment of the present application provides an optical fiber connector 110, which is schematically shown in FIGS. 1 to 10. The optical fiber connector 110 is used to mate with the optical fiber adapter, for example, an optical fiber adapter 160 of a second preferred embodiment or an optical fiber adapter 260 of a fourth preferred embodiment of the present application, to form an optical fiber connection system, for example, an optical fiber connection system 100 of a third preferred embodiment or an optical fiber connection system 200 of a fifth preferred embodiment of the present application.

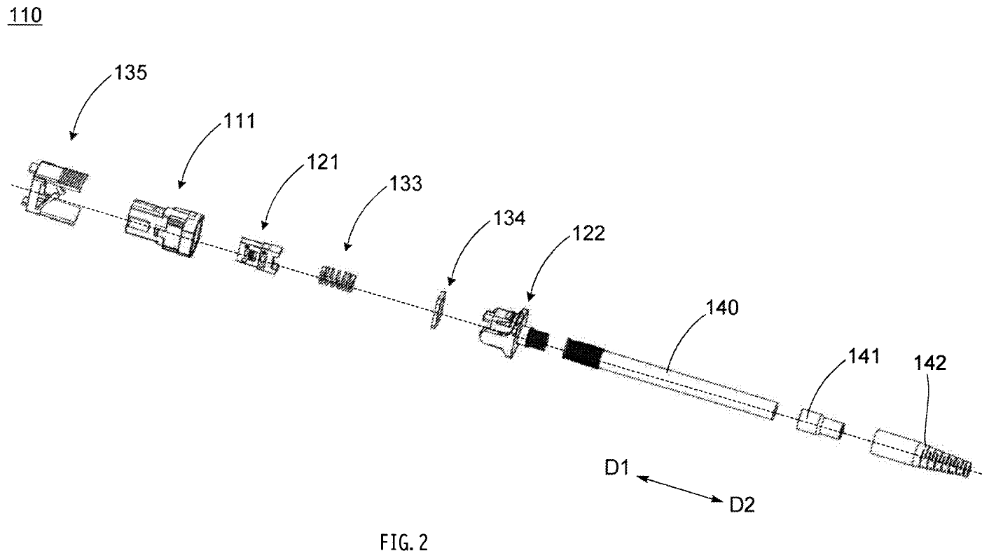

Referring to FIGS. 1 and 2, the optical fiber connector 110 according to the first preferred embodiment of the present application is schematically illustrated. An outer housing 135, an inner housing 111, a ferrule assembly 121, an elastic member 133, a sealing component 134, a rear body 122, an optical cable 140, a crimp ring 141 and a boot 142 may be seen in sequence from FIG. 2. Wherein the inner housing 111, the outer housing 135 and the ferrule assembly 121 are located at a proximal end of the optical fiber connector 110 for connecting with the optical fiber adapter.

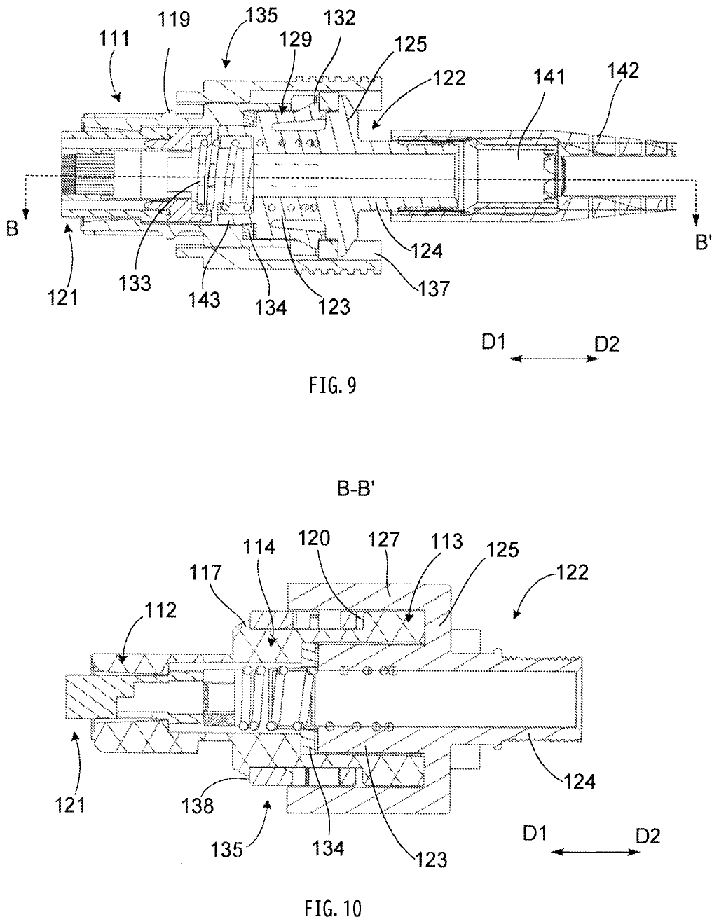

In the following description, the proximal end of the connector is used to describe the end of the connector connected to the adapter, and a distal end is used to describe an optical cable end of the connector. Moreover, taking FIG. 9 as an example, a direction extending from the distal end to the proximal end is referred to as a forward direction (i.e., a D1 direction in FIG. 9); a direction extending from the proximal end to the distal end is referred to as a backward direction (i.e., a D2 direction in FIG. 9); a direction (i.e., the up-down direction in FIG. 9) in which the optical fibers are arranged in the ferrule assembly is referred to as a longitudinal direction of the optical fiber connector; and a direction (i.e., the direction that is perpendicular to the paper surface in FIG. 9) perpendicular to the front-back direction and the longitudinal direction at the same time is referred to as a transverse direction of the optical fiber connector.

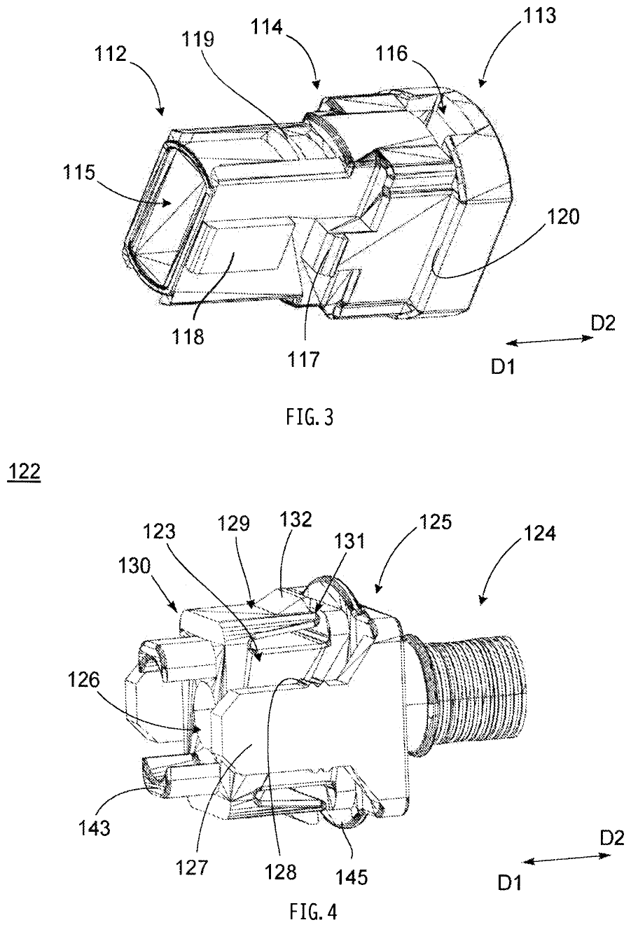

Referring to FIGS. 1, 2, 3 and 10, the inner housing 111 includes a front end portion 112, a middle portion 114, a rear end portion 113, and an open space 115 is formed therein. The middle portion 114 is connected between the front end portion 112 and the rear end portion 113. The open space 115 extends through from the front end portion 112 to the rear end portion 113. The front end portion 112 is used for insertion into the optical fiber adapter 160. As shown in FIGS. 1 and 3, the two side surfaces of the front end portion 112 extending along the longitudinal direction are substantially flat, and one of the side surfaces is provided with a polarity key 118. The two side surfaces of the front end portion 112 extending along the transverse direction are flat and slightly curved, and protrusions extending along the front-back direction may be provided on both sides thereof, and a third engaging portion 119 (described below) is provided on the further behind portion. The rear end portion 113 is used to receive the rear body 122. The rear end portion 113 may be provided with a first engaging portion 116 (described below) on a side surface thereof extending along the transverse direction. The middle portion 114 is preferably provided with a second engaging portion 117 (described below). Preferably, the inner housing 111 is formed as an integral member.

The ferrule assembly 121 is disposed in the open space 115 of the inner housing 111, and is used to connect and accommodate optical fibers, such as optical fibers protruding from the optical cable 140. Moreover, the ferrule assembly 121 is at least partially exposed from the front end portion 112.

Referring to FIGS. 4, 9 and 10, the rear body 122 includes an insertion portion 123, a transition portion 125, and an exposed portion 124, and an optical fiber channel 126 is formed therein. The transition portion 125 is connected between the insertion portion 123 and the exposed portion 124. The exposed portion 124 is used to receive the optical fiber, and it may be configured as a cylinder-like shape as shown. The optical fiber channel 126 extends from the exposed portion 124 to the insertion portion 123 and communicates with the open space 115. The insertion portion 123 is at least partially inserted into the rear end portion 113 in the forward direction D1, and the transition portion 125 is attached to the rear end portion 113 of the inner housing 111. Preferably, the cross-sectional dimension of the transition portion 125 along a direction perpendicular to the forward direction D1 is greater than that of the insertion portion 123, such that the transition portion 125 may abut against the rear end portion 113. Moreover, lugs 145, such as semicircular or fan-shaped lugs 145, are preferably provided on the two side surfaces of the transition portion 125 extending along the transverse direction, so that it is easier to abut against the rear end portion 113. The rear body 122 has a first matching portion 129 configured to engage with the first engaging portion 116.

As shown in FIG. 3, the inner cross-sectional dimension of the rear end portion 113 of the inner housing 111 along a direction perpendicular to the forward direction D1 is greater than that of the middle portion 114, thereby forming a stepped structure here. In other words, the open space 115 may be formed as a stepped hole. After the insertion portion 123 is inserted from the rear end portion 113, the insertion portion 123 abuts against the rear end of the middle portion 114. That is, referring to FIG. 9, the insertion portion 123 abuts on the step of the above-mentioned stepped hole.

The clastic member 133 is disposed in the open space 115 and between the ferrule assembly 121 and the rear body 122, and the rear body 122 is configured to press the clastic member 133 on the ferrule assembly 121. Specifically, the surface of the insertion portion 123 toward the forward direction D1 is provided with an accommodating portion 143, and the elastic member 133 is located in the accommodating portion 143. The elastic member 133 is configured to press the rear body 122 such that the rear body 122 tends to move toward the backward direction D2 to allow the first engaging portion 116 to snap tightly with the first matching portion 129. Meanwhile, the elastic member 133 is configured to press the ferrule assembly 121 so that it can be relatively secured at the front end portion 112 of the inner housing 111, thereby making it relatively secure at the proximal end of the optical fiber connector 110.

The sealing component 134 is disposed between the inner housing 111 and the rear body 122 and abuts against the insertion portion 123, and the rear body 122 is configured to press the sealing component 134 on the inner housing 111. For example, the sealing component 134 is sandwiched between the insertion portion 123 of the rear body 122 and the middle portion 114 of the inner housing 111. In the illustrated embodiment, the insertion portion 123 of the rear body 122 presses the sealing component 134 onto the step of the stepped hole formed in the above-mentioned open space 115.

According to the optical fiber connector 110 of the present embodiment, the connection between the rear body 122 and the inner housing 111 is achieved by using the snap-fit structure, which not only facilitates the assembling of the connector but also avoids the displacement of the optical fiber, for example, avoids the fracture and damage of the optical fiber caused by the displacement of the threaded installation between the rear body and the inner housing. Moreover, the waterproof function is also achieved by providing the sealing component 134, which may prevent liquid from entering the interior of the device through the connector.

Referring to FIGS. 3, 4 and 9, the first engaging portion 116 may be configured as an opening on a side surface of the rear end portion 113 of the inner housing 111 extending along the transverse direction. The first matching portion 129 is disposed to the insertion portion 123, and may have a protruding portion 132, thereby enabling it to be snap-fitted with the first engaging portion 116 in the form of the opening. The first matching portion 129 has a first end 130 and a second end 131 opposite to the first end 130, wherein the second end 131 is closer to the distal end of the optical fiber connector 110 than the first end 130. The first end 130 is connected to the insertion portion 123, and the second end 131 is spaced apart from an outer surface of the insertion portion 123. The above-mentioned protruding portion 132 is arranged at the second end 131, for example, the protruding portion 132 protrudes at the second end 131 along a direction away from the insertion portion 123. The first matching portion 129 can be deformed to make the second end 131 close to the outer surface of the insertion portion 123 to allow the protruding portion 132 to enter the opening to form a snap-fit. Exemplarily, during the insertion of the rear body 122 into the inner housing 111, the protruding portion 132 of the first matching portion 129 on the rear body 122 first comes into contact with the rear end portion 113 of the inner housing 111, so that the first matching portion 129 is deformed when pressing the rear end portion 113 to allow the protruding portion 132 to enter the rear end portion 113. When the protruding portion 132 moves into the opening, the first matching portion 129 resumes its shape such that the protruding portion 132 is snap-fitted with the opening.

Referring to FIGS. 1, 4 and 10, the transition portion 125 of the rear body 122 has a key portion 127 located on both side surfaces of the rear body 122 extending in the longitudinal direction. The key portion 127 extends toward the forward direction D1 and is spaced apart from the insertion portion 123, such that the rear end portion 113 of the inner housing 111 can be sandwiched between the key portion 127 and the insertion portion 123, thereby further improving the stability of the connection. Preferably, the side surface (the side extending in the longitudinal direction) of the key portion 127 is provided with a concave-convex structure 128. The key portion 127 is used to be inserted into a keyway opening 168 on the optical fiber adapter 160, and the concave-convex structure 128 can form a matching connection with an additional concave-convex structure 169 on a side wall of the keyway opening 168, so as to limit the shaking of the optical fiber connector 110 and prevent the occurrence of sound.

Referring to FIGS. 1, 2, 5 and 9, the optical fiber connector 110 includes an outer housing 135. The outer housing 135 includes a frame portion 136 and an operating portion 137 connected to the frame portion 136. Exemplarily, the frame portion 136 may be configured as a hollow frame-like shape, or two beams facing each other and spaced apart. The operating portion 137 is provided on two side surfaces of the frame portion 136 disposed opposite in the longitudinal direction, and extends from the frame portion 136 in the backward direction D2. The operating portion 137 is used to be held and operated by an operator, and the outer surface thereof may optionally be provided with anti-skid lines. The frame portion 136 is provided with a second matching portion 138. The outer housing 135 surrounds around the inner housing 111 along the backward direction D2. Correspondingly, the middle portion 114 of the inner housing 111 is provided with a second engaging portion 117 that can form a snap-fit with the second matching portion 138. The second engaging portion 117 is preferably disposed on a side surface extending along the longitudinal direction, e.g., located behind the polarity key 118 on one side surface.

Optionally, the second engaging portion 117 is configured as a projection 117 protruding from the outer surface of the inner housing 111, and the second matching portion 138 is configured as an end portion of the frame portion 136 along the forward direction D1. The frame portion 136 is located behind the projection 117 when the second engaging portion 117 forms a snap-fit with the second matching portion 138.

The rear end portion 113 of the inner housing 111 is provided with a blocking portion 120. Exemplarily, the outer cross-sectional dimension of the rear end portion 113 of the inner housing 111 along a direction perpendicular to the forward direction D1 is greater than that of the middle portion 114, such that the outer portion of the inner housing 111 also forms a stepped structure that forms the above-mentioned blocking portion 120. The frame portion 136 of the outer housing 135 has elastic portion(s) 139 abutting against the blocking portion 120, such that the outer housing 135 tends to move toward the forward direction D1 to make the second engaging portion 117 snap tightly with the second matching portion 138. In the illustrated embodiment, the clastic portion(s) 139 may be deformable elastic arms extending obliquely toward the backward direction D2.

Furthermore, as shown in FIGS. 3 and 9, the front end portion 112 is also provided with a third engaging portion 119 for matching with a hook portion 185 of a hook element 171 of the optical fiber adapter 160 so that the optical fiber connector 110 can be secured after it is inserted into the optical fiber adapter 160. The third engaging portion 119 is preferably a protrusion extending in the transverse direction, with a trapezoidal cross section, to facilitate guiding the hook portion 185 on the hook element 171 of the optical fiber adapter. Therefore, the third engaging portion 119 may also be referred to as an inclined portion 119, and a groove between the inclined portion 119 and the middle portion 114 forms a locking groove. Furthermore, the inclined portion 119 and the locking groove jointly form a snap-fit structure, such that the hook portion 185 on the hook element 171 enters into the locking groove to form a snap fit.

FIGS. 6, 7 and 8 illustrate an assembly process of the optical fiber connector 110. Wherein reference is made to FIG. 6 for a first step of assembly. The inner housing 111, the ferrule assembly 121, the elastic member 133, the sealing component 134 and the rear body 122 are first assembled together. The installation direction may be either to snap the inner housing 111 with the rear body 122 in the backward direction D2, or to snap the rear body 122 with the inner housing 111 in the forward direction D1.

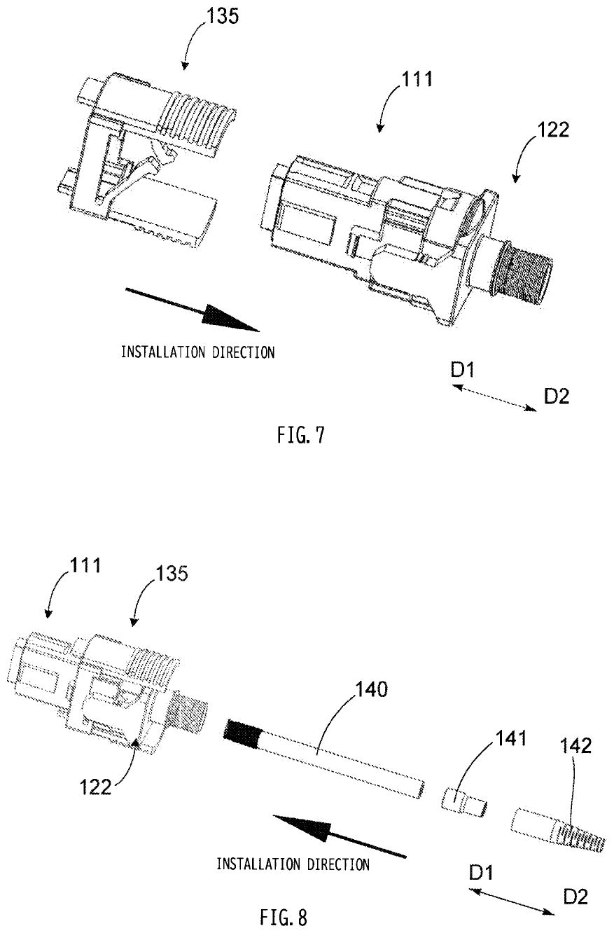

Reference is made to FIG. 7 for a second step of assembly. The outer housing 135 is sleeved outside the inner housing 111 along the backward direction D2, such that the frame portion 136 is located behind the projection 117, and the elastic portion(s) 139 of the frame portion 136 abuts against the blocking portion 120 further behind, such that the position of the outer housing 135 is limited by the projection 117 and the blocking portion 120.

Reference is made to FIG. 8 for a third step of assembly. The optical cable 140 is connected to the exposed portion 124 of the rear body 122, and the optical fibers in the optical cable 140 is connected to the ferrule assembly 121 via the optical fiber channel 126. Afterwards, the crimp ring 141 is connected to the exposed portion 124, and the optical fibers are compressed by the rotation of the threaded connection and the fixing teeth on the inner surface of the crimp ring 141. Then, the boot 142 is sleeved on the exposed portion 124. The boot 142 may be a heat shrinkable boot. The optical cable 140, the crimp ring 141, and the rear body 122 are fastened together by the heat shrinkage of the boot 142.

### Second Preferred Embodiment

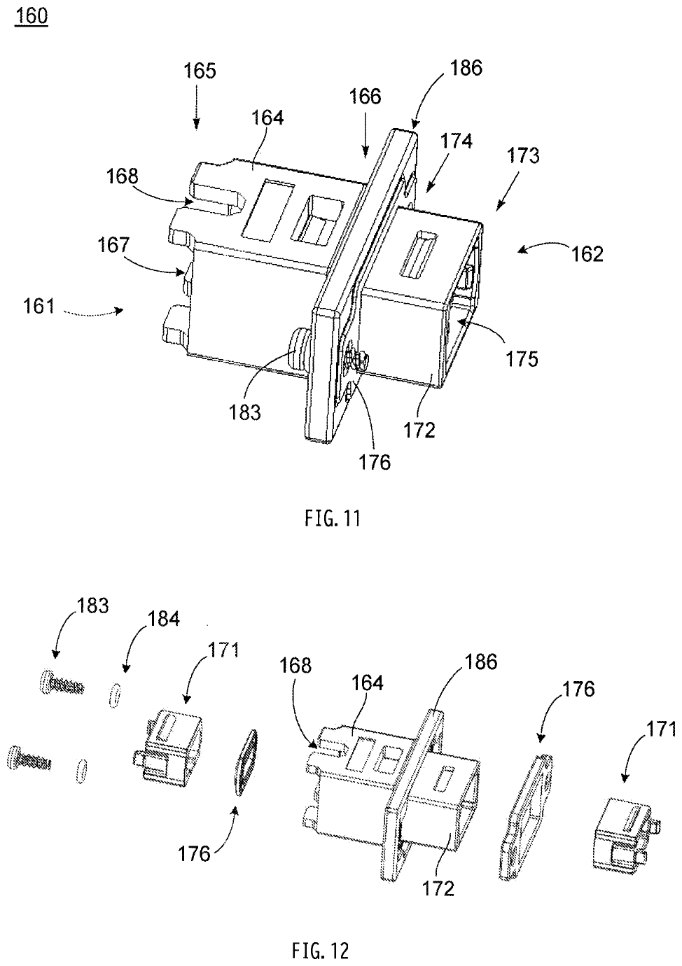

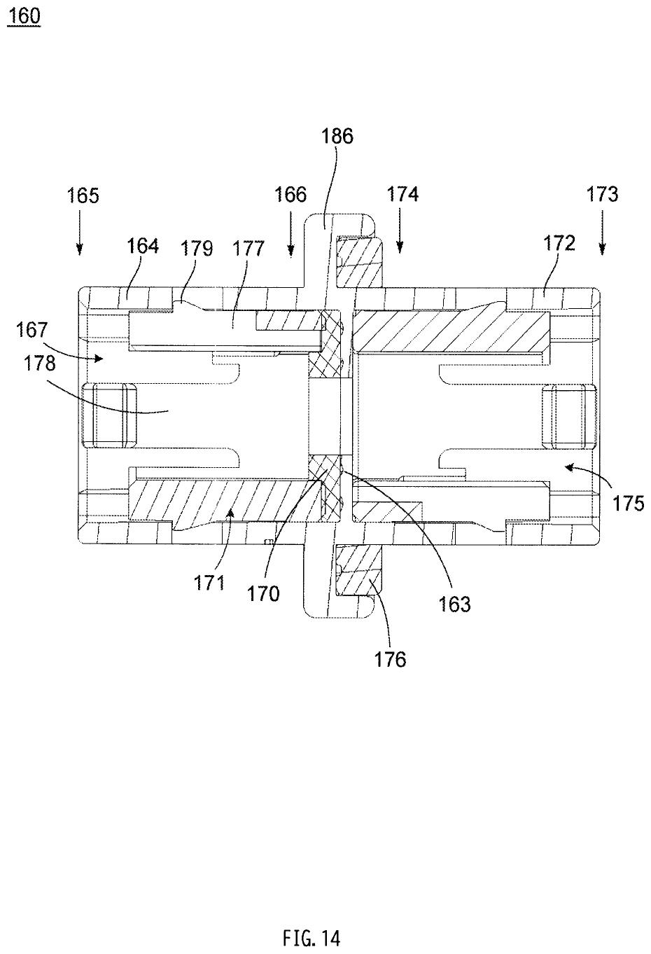

The second preferred embodiment of the present application provides an optical fiber adapter 160, which is shown in FIGS. 11 to 14. In this embodiment, a longitudinal direction of the optical fiber adapter is the same as that of the optical fiber connector in the first embodiment, which is the direction perpendicular to the paper surface in FIG. 14. A transverse direction of the optical fiber adapter is the same as that of the optical fiber connector in the first embodiment, which is the up-down direction in FIG. 14.

The optical fiber adapter 160 of the second preferred embodiment of the present application includes two oppositely disposed receiving portions and a partition wall 163 located between the two receiving portions. For example, the optical fiber adapter 160 in this embodiment includes a first receiving portion 161, a second receiving portion 162, and a partition wall 163 connected between the first receiving portion 161 and the second receiving portion 162.

Wherein, the first receiving portion 161 is used for receiving a first optical fiber connector 110, which may be the optical fiber connector 110 in the above-mentioned first preferred embodiment. The second receiving portion 162 is used for receiving a second optical fiber connector 10, which may be an optical fiber connector different from that in the above-mentioned first preferred embodiment, such as a standard optical fiber connector.

Referring to FIGS. 11, 12 and 14, the first receiving portion 161 includes a first housing 164, a first sealing member 170, and a hook element 171. The first housing 164 has a first insertion end 165, a first mating end 166, and a first passage 167 extending from the first insertion end 165 to the first mating end 166. The first insertion end 165 is used for insertion of the first optical fiber connector 110, and the first mating end 166 is used for mating with the second optical fiber connector 10. The first sealing member 170 is disposed to the first mating end 166 and is attached to the partition wall 163. The hook element 171 is disposed in the first housing 164 and is configured to press the first sealing member 170 to the partition wall 163. The hook element 171 has an accommodating space 181 for accommodating at least part of the optical fiber connector 110.

The second receiving portion 162 is disposed oppositely with respect to the first receiving portion 161 and includes a second housing 172 and another hook element 171. Wherein the second housing 172 has a second insertion end 173, a second mating end 174, and a second passage 175 extending from the second insertion end 173 to the second mating end 174. The second passage 175 is in communication with the first passage 167 at the partition wall 163. For example, the partition wall 163 may be provided with a through-hole (which may also be referred to as a partition wall through-hole) through which the second passage 175 is in communication with the first passage 167. Moreover, the above-mentioned first sealing member 170 is attached to the partition wall 163 around the through-hole. The second insertion end 173 is used for insertion of the second optical fiber connector 10, and the second mating end 174 is used for mating with the first optical fiber connector 110. Another hook element 171 is disposed in the second housing 172, which has the same structure as the hook element 171 in the first receiving portion 161.

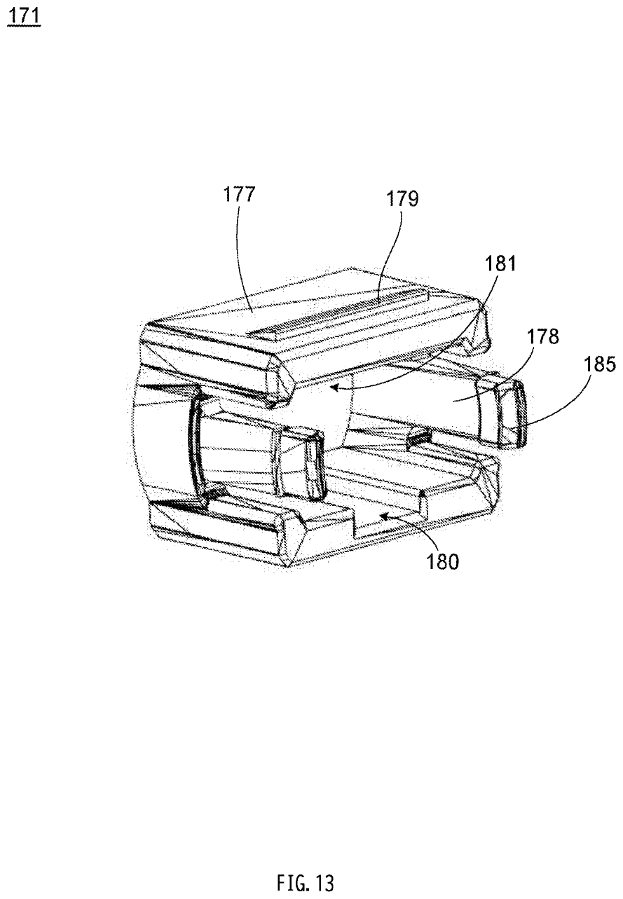

Exemplarily, referring to FIG. 13, each hook element 171 of each first receiving portion 161 and second receiving portion 162 includes a hook body 177, side arms 178, a locking portion 179 and a polarity portion 180. The accommodating space 181 is formed within the hook body 177 for accommodating a part of the optical fiber connector. The accommodating space 181 passes through the hook element 171, which may be regarded as forming a part of the first passage 167 or the second passage 175. The side arms 178 are connected to two opposing sides of the hook body 177 along the longitudinal direction and are configured to lock the optical fiber connector 110 when the optical fiber connector 110 is inserted into the optical fiber adapter 160. For example, the hook portion 185 at the end of the side arm 178 is snap-fitted with the third engaging portion 119 on the side surface of the inner housing 111 of the optical fiber connector 110. The locking portion 179 is disposed on an outer surface of the hook body 177, such as two side surfaces of the hook body 177 that are disposed oppositely with each other along the transverse direction. The side surface may be a flat surface from which the locking portion 179 protrudes. The locking portion 179 is configured to allow the hook element 171 to be connected to the housing of the receiving portion. Exemplarily, the two outer side surfaces, opposite to each other along the transverse direction, of the housing of the receiving portion are provided with a clamping slot (which may also be referred to as a matching window), and the locking portion 179 on the hook body 177 can snap fit with the clamping slot or the matching window. The polarity portion 180 is disposed on an inner surface of the hook body 177, e.g., the polarity portion 180 may be disposed on one of the two inner surfaces arranged opposite to each other along the transverse direction. The polarity portion 180 is used to receive a polarity key 118 on the optical fiber connector 110. In the illustrated embodiment, the polarity portion 180 is configured as a polarity slot 180 recessed in the inner surface of the hook body 177.

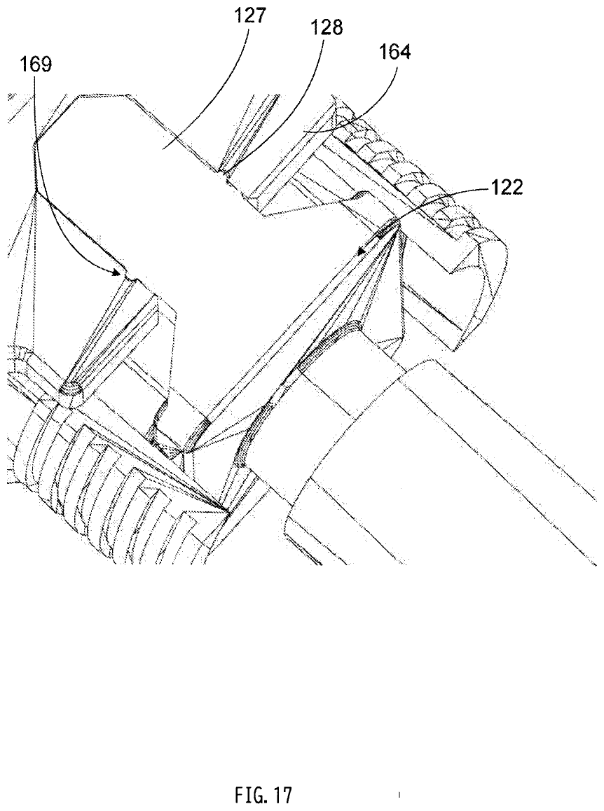

Preferably, the respective polarity portions 180 of the two hook elements 171 of the first receiving portion 161 and the second receiving portion 162 are oppositely oriented. In this embodiment, the inner surface of the hook element 171 in the first receiving portion 161 is configured to closely fit the outer surface of the front end portion 112 of the inner housing 111 of the first optical fiber connector 110 to improve the stability of insertion, thereby reducing the possibility of waterproofing failure and improving the performance of waterproof. Preferably, the first insertion end 165 of the first housing 164 is provided with keyway openings 168 located on two opposite side surfaces of the first housing 164 along the transverse direction. The keyway opening 168 is used to receive the key portion 127 of the first optical fiber connector 110. The periphery of the keyway opening 168 is provided with an additional concave-convex structure 169 to match the concave-convex structure 128 on the key portion 127 of the first optical fiber connector 110, thereby limiting the shaking of the first optical fiber connector 110 and preventing the sound (see FIG. 17). One of the additional concave-convex structure 169 and the concave-convex structure 128 is convex, and the other is concave, and vice versa. In this way, these two may also be snap-fitted, thereby further preventing the optical fiber connector 110 from shaking in the forward direction D1 and the backward direction D2, preventing the failure of waterproof caused by back-and-forth shaking.

Moreover, the first insertion end 165 of the first housing 164 preferably extends in a direction away from the partition wall 163 to surround the middle portion 114 of the inner housing 111 of the first optical fiber connector 110. As a result, the possibility of up-down and left-right shaking of the optical fiber connector 110 may be further reduced so as to further improve the connection stability and avoid the failure of the waterproof.

Preferably, the optical fiber adapter 160 in this embodiment further includes a blocking wall 186 (which may also be referred to as a mounting portion 186) and a second sealing member 176. The blocking wall 186 is disposed around the first receiving portion 161 at the junction of the first receiving portion 161 and the second receiving portion 162. A receiving groove is disposed on a side surface of the blocking wall 186 facing the second receiving portion 162. The second sealing member 176 is disposed around the second receiving portion 162 and is attached within the receiving groove.

The optical fiber adapter 160 of this embodiment may be used for optical connection on a device. For example, the optical fiber adapter 160 of this embodiment is arranged to the device with the blocking wall 186 secured to the device by using fasteners 183 and gaskets 184. The second sealing member 176 is located between the blocking wall 186 and an outer surface of the device, which prevents water from entering the interior of the device from the connection between the optical fiber adapter 160 and the device casing.

### Third Preferred Embodiment

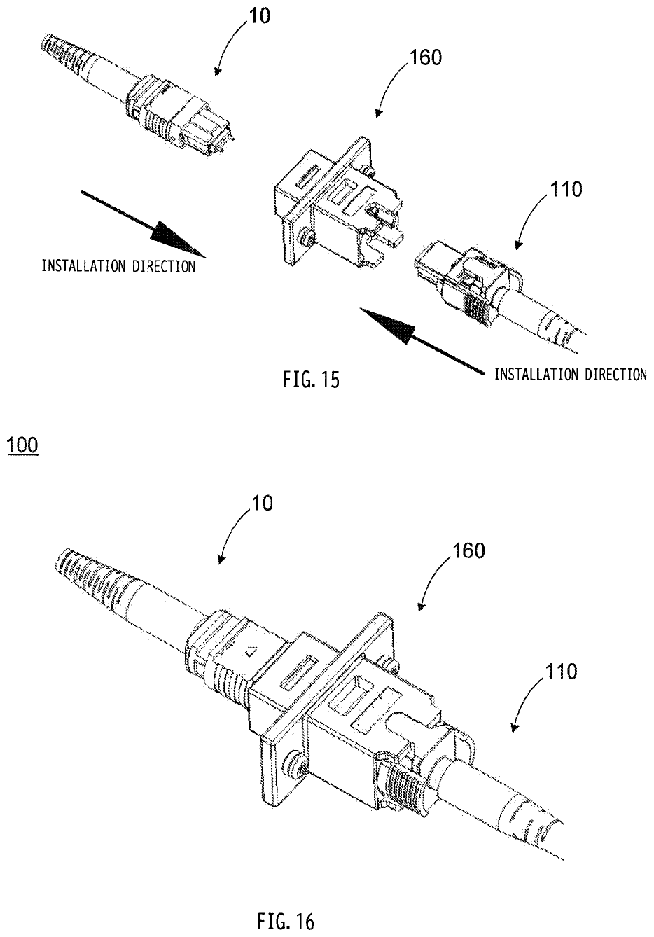

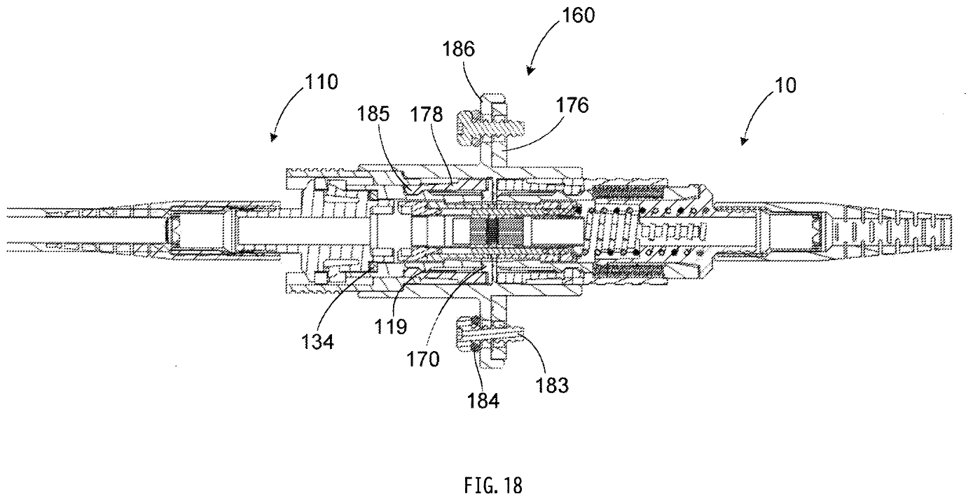

The third preferred embodiment of the present application provides an optical fiber connection system 100, which is illustrated in FIGS. 15 to 18.

The optical fiber connection system 100 of the third preferred embodiment of the present application includes the optical fiber adapter 160 in the second preferred embodiment, a first optical fiber connector 110 and a second optical fiber connector 10. The first optical fiber connector 110 is configured as the optical fiber connector 110 in the first preferred embodiment of the present application. The second optical fiber connector 10 is configured as an optical fiber connector different from that of the first preferred embodiment, such as a standard optical fiber connector.

The optical fiber connection system 100 of this embodiment may be used for connection between optical cables and devices. For example, an external optical cable is connected to the first optical fiber connector 110, and the optical cables of devices are connected to the second optical fiber connector 10.

The first optical fiber connector 110 and the second optical fiber connector 10 are pushed into the first receiving portion 161 and the second receiving portion 162 of the optical fiber adapter 160, respectively. The first optical fiber connector 110 presses the first sealing member 170 in the first receiving portion 161 to achieve sealing between the external environment and the optical fiber connection system 100. Moreover, the optical fiber adapter 160 is connected to the device casing by fasteners 183 and gaskets 184 to compress the second sealing member 176 to achieve sealing between the external environment and the device.

### Fourth Preferred Embodiment

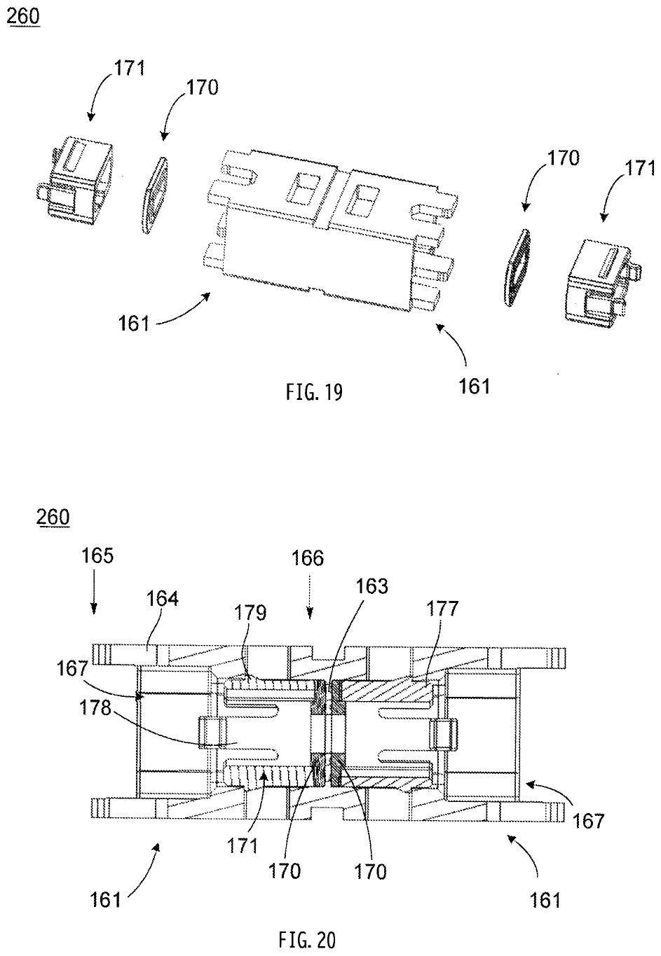

The fourth preferred embodiment of the present application provides an optical fiber adapter 260, which is illustrated in FIGS. 19 to 20.

The optical fiber adapter 260 of the fourth preferred embodiment of the present application is a variation of the optical fiber adapter 160 of the second preferred embodiment. Accordingly, elements with functions substantially identical to those in the second preferred embodiment will be numbered identically herein and will not be described and/or illustrated in detail for the sake of brevity.

The difference between the optical fiber adapter 260 in the fourth preferred embodiment of the present application and the optical fiber adapter in the second preferred embodiment lies in that the optical fiber adapter 260 includes two oppositely disposed first receiving portions 161 and a partition wall 163 between the two first receiving portions 161. Two first sealing members 170 of the two first receiving portions 161 are attached to the partition wall 163 opposite to each other, and the two first passages 167 of the two first receiving portions 161 communicate at the partition wall 163.

The optical fiber adapter 260 in the fourth preferred embodiment of the present application does not have the blocking wall 186 and the second sealing member 176 as in the second preferred embodiment. Moreover, the respective polarity portions 180 of the two hook elements 171 of the two first receiving portions 161 are oppositely oriented.

### Fifth Preferred Embodiment

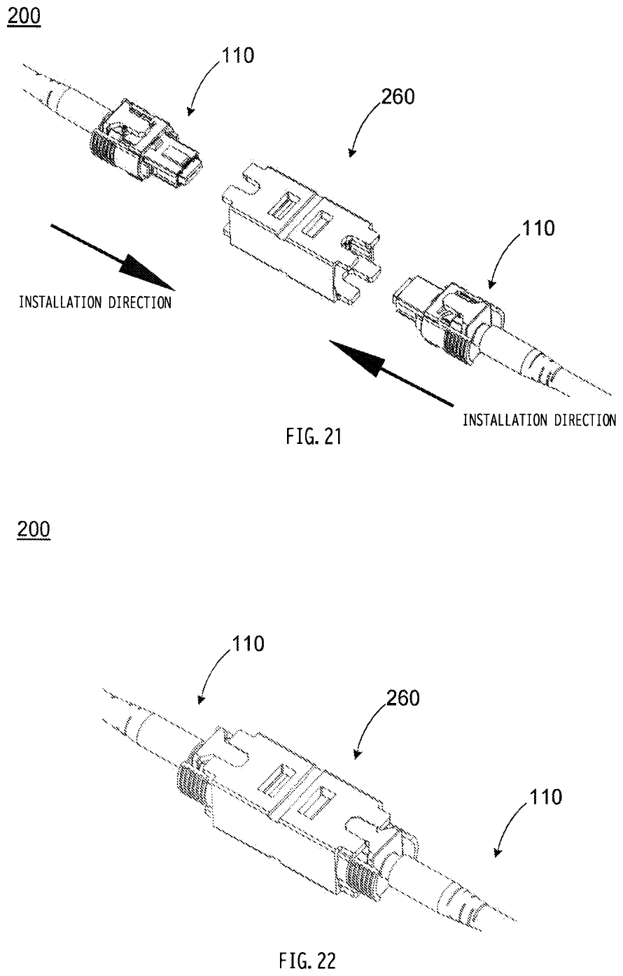

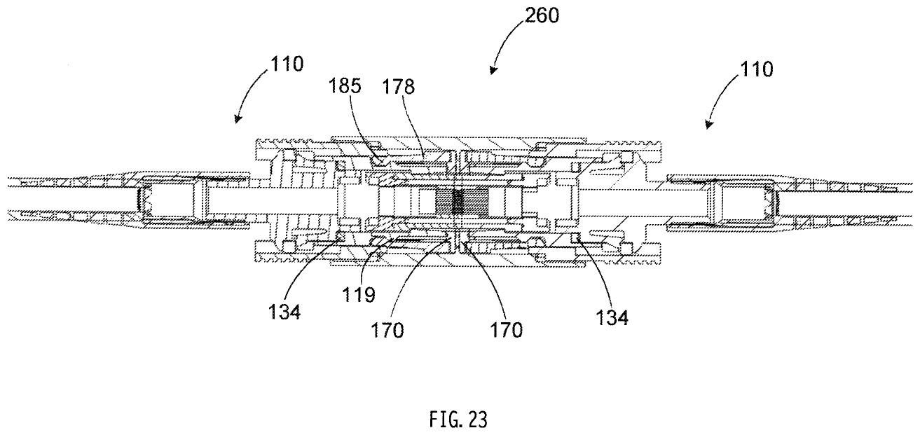

The fifth preferred embodiment of the present application provides an optical fiber connection system 200, which is illustrated in FIGS. 21 to 23.

The optical fiber connection system 200 of the fifth preferred embodiment of the present application includes the optical fiber adapter 260 of the fourth preferred embodiment and two optical fiber connectors 110 of the first preferred embodiment of the present application.

The optical fiber connection system 200 in this embodiment may be used for connecting optical cable to optical cable. For example, two optical cables are connected to the two first optical fiber connectors 110, respectively. The two first optical fiber connectors 110 are pushed into the two first receiving portions 161 of the optical fiber adapter 260, respectively. Two first sealing members 170 of the two receiving portions are compressed by each first optical fiber connector 110, thereby achieving the seal between the external environment and the optical fiber connection system 200.

According to the optical fiber connection system of the present application, by providing waterproof components in the connector and the adapter respectively, when the connector is connected to the adapter, the inner housing of the connector abuts against the waterproof components at the front and rear ends respectively, so that the connection openings between the device and the external environment are sealed by waterproof components to effectively prevent moisture from entering the interior of the device.

### Sixth Preferred Embodiment

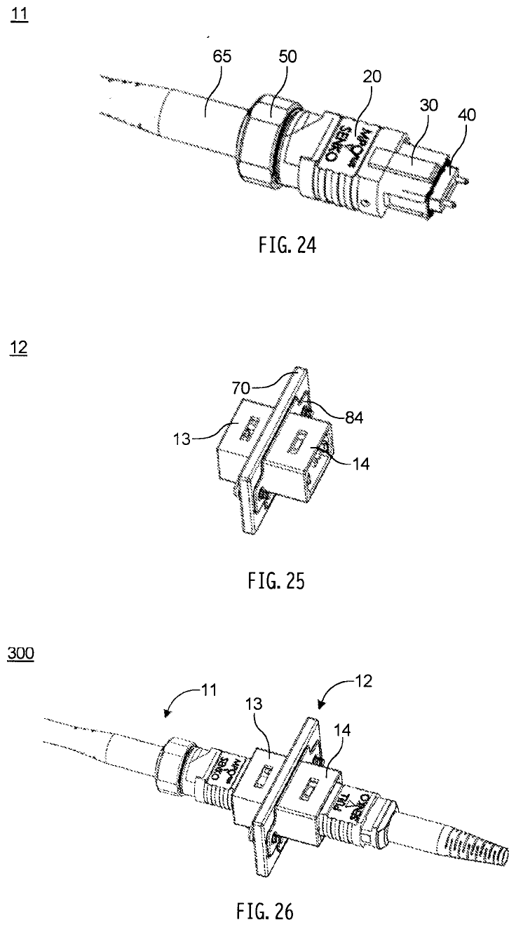

The sixth preferred embodiment of the present application provides an optical fiber connector 11, which is illustrated in FIGS. 24, 27 to 31 and 37 to 39. In this embodiment, the axial direction is a direction parallel to the direction in which the optical fiber extends, and the axial direction is also referred to as the front-back direction. The cross-section is a section perpendicular to the axial direction.

In FIG. 24, the optical fiber connector 11 includes an outer housing 20, an inner housing 30, a rear post 50 (also referred to as a rear body 50), and a boot 65. The outer housing 20 may be disposed around the inner housing 30. A ferrule 40 (which may also be referred to as a ferrule assembly 40) is disposed in the inner housing 30 and is exposed from one end of the inner housing 30. The ferrule 40 includes a plurality of optical fibers.

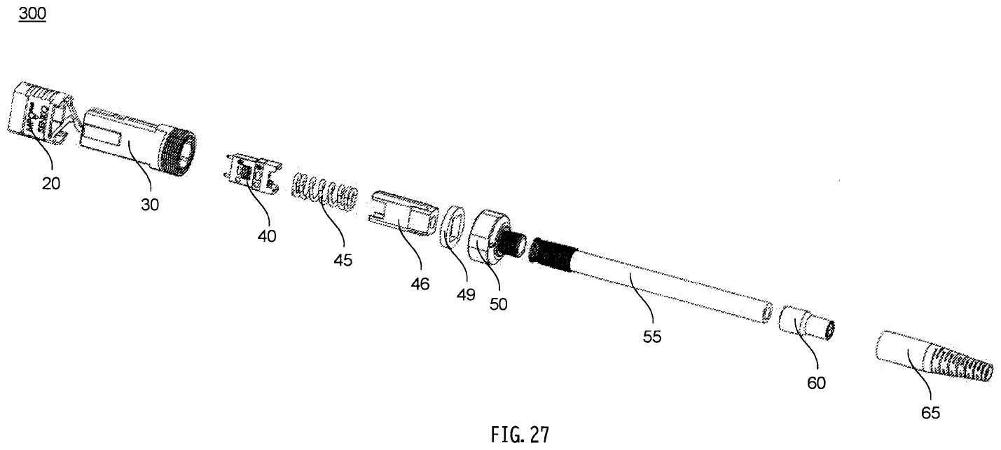

In FIG. 27, the optical fiber connector 11 further includes a spring 45 (which may also be referred to as an elastic member 45), with one end of the spring 45 abutting against the ferrule 40 and the other end abutting against a stopper 46, such that the ferrule 40 may move within the inner housing 30 after pressure is applied and return to its original position after the pressure is removed. The connector gasket 49 (which may also be referred to as a sealing component 49) is disposed between the inner housing 30 and the rear post 50. The inner housing 30 and the rear post 50 may be connected by threads, and the connector gasket 49 is pressed when they are connected, which in turn prevents moisture and impurities, etc., from entering the interior of the connector. The optical cable 55 is connected to the rear post 50 via a clamping ring 60 (which may also be referred to as a crimp ring 60). The boot 65 is sheathed on the periphery of the optical cable 55.

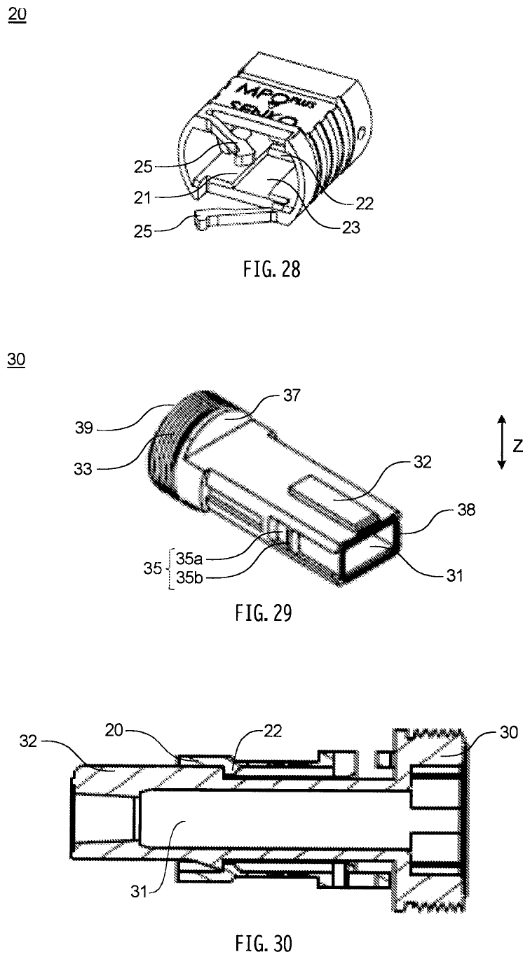

As shown in FIG. 28, the outer housing 20 includes an inner space 21 for accommodating the inner housing 30. An axially extending groove 23 is disposed in the inner space 21, and the groove 23 may guide the insertion of the inner housing 30 into the outer housing 20. The groove 23 includes a protruding part 22 that may limit the outer housing 20 at a predetermined position and prevent the outer housing 20 from disengaging from the inner housing 30. The inner housing 30 protrudes from one end of the outer housing 20, and the opposite end of the outer housing 20 is provided with flexible arm(s) 25 (which may also be referred to as an clastic portion(s) 25). The flexible arm(s) 25 may extend outward from the main body of the outer housing 20 and has an elastic recovery force. As illustrated, the outer housing 20 includes two flexible arms 25 extending in different directions.

In FIG. 29, the inner housing 30 includes an accommodating space 31 (which may also be referred to as an open space 31), and the ferrule 40 is arranged in the accommodating space 31 and protrudes therefrom. The inner housing 30 includes a front end 38 (which may also be referred to as a front end portion) and a rear end 39 (also referred to as a rear end portion). The inner housing 30 is provided with a key portion 32 (also called a polarity key 32) near the front end 38. The rear end 39 includes an external threaded portion 33 and is also provided with a blocking portion 37 against which the flexible arms 25 may abut, thereby preventing the inner housing 30 from being separated from the outer housing 20. The inner housing 30 includes a snap-fit structure 35 disposed on both sides, and the snap-fit structure 35 includes a locking groove 35a and an inclined portion 35b.

FIG. 30 shows the connection state of the inner housing 30 and the outer housing 20. The front end 38 of the inner housing 30 protrudes from the outer housing 20, and the key 32 is received in the groove of the outer housing 20 and abuts against the protruding part 22, thereby restricting the movement of the outer housing 20 relative to the inner housing 30 toward the front end 38 and preventing the outer housing 20 from disengaging from the inner housing 30. The snap-fit structure 35 is covered by the outer housing 20. The flexible arms 25 abut against the blocking portion 37 and is in an initial state, and at this time, the outer housing 20 is in the first position. When the outer housing 20 is subjected to a backward external force (described in detail below), the outer housing 20 moves toward the rear end 39 relative to the inner housing 30 and the flexible arms 25 are pressed, that is, the outer housing 20 is in the second position. When the external force is removed, under the action of the elastic recovery force of the flexible arm 25, the outer housing 20 moves toward the front end 38 relative to the inner housing 30 and is restricted by the key portion 32, thereby returning to the first position. Moreover, the key portion 32 or the polarity key 32 may also cooperate with the polarity portion or polarity groove on a hook element 90 to indicate the polarity of the connector when mated together.

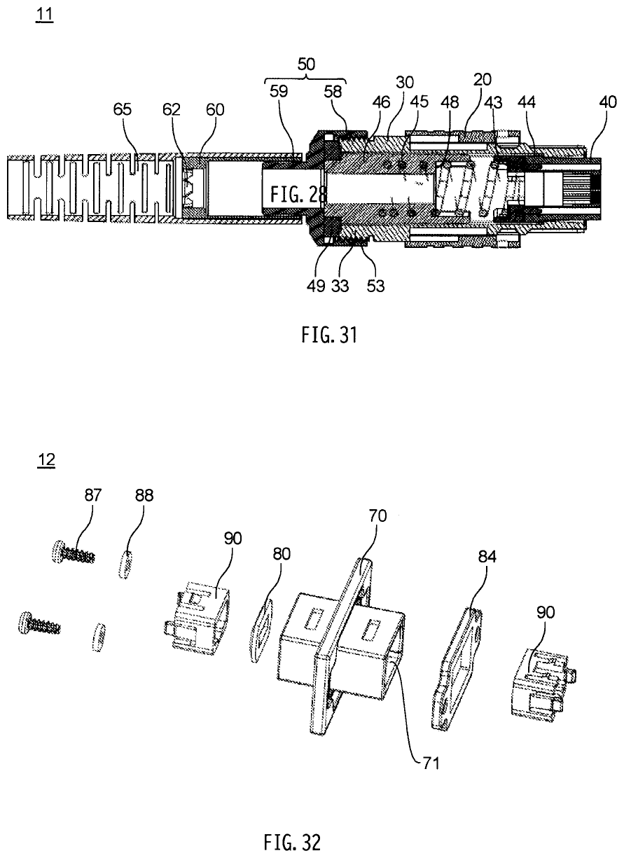

As shown in FIG. 31, the rear post 50 is connected to the inner housing 30 through threads. Specifically, the rear post 50 includes a rear body head end 58 and a rear body tail end 59. The rear body head end 58 includes internal threads 53 so that the rear post 50 may be threadedly connected to the external threaded portion 33 of the inner housing 30. The stopper 46 is disposed in the inner housing 30. One end of the spring 45 is received in the stopper 46, and under the clastic force of the spring 45, the ferrule 40 may be exposed from the front end 38 of the inner housing 30 and move forward and backward relative to the inner housing 30. When the optical fiber connector 11 is connected to the adapter 12, the ferrule 40 can move back and forth in the axial direction due to the bias of the spring 45, thereby achieving a tight connection with the mated connector and eliminating the gap.

The connector gasket 49 may be configured in the form of steps such that, for example, the thickness of the middle portion of the connector gasket 49 is greater than that of the edge portion thereof. The inner housing 30 contacts the connector gasket 49 at the edge portion of the connector gasket 49, and the stopper 46 contacts the connector gasket 49 at the middle portion thereof.

As is well known to those skilled in the art, the optical fiber cable 55 is connected to the rear body tail end 59. The clamping ring 60 is sleeved on the outside of the optical cable 55 and also connected to the rear body tail end 59. As shown in FIG. 31, the clamping ring 60 includes fixing teeth 62 protruding toward the inside of the clamping ring 60 to secure the sheath of the optical cable 55 to the rear body tail end 59 in a pressing manner. The boot 65 is sheathed on the outer surface of the clamping ring 60 at the rear end.

### Seventh Preferred Embodiment

The seventh preferred embodiment of the present application provides an optical fiber adapter 12, which is shown in FIGS. 25 and 32 to 39. In this embodiment, the axial direction is a direction parallel to the direction in which the optical fiber extends, and is also referred to as the front-back direction. The cross-section is a section perpendicular to the axial direction.

In FIG. 25, the optical fiber adapter 12 according to the present application includes a first end portion 13 (which may also be referred to as a first receiving portion 13) and a second end portion 14 (which may also be referred to as a second receiving portion 14). The first end portion 13 and the second end portion 14 are used for connecting the optical fiber connector, respectively.

In FIG. 32, the optical fiber adapter 12 includes an adapter housing 70, a first sealing member 80, a hook member 90 and a second sealing member 84. The first sealing member 80 and the hook element 90 are received in the adapter housing 70 that may be mounted to a device by bolts 87 and bolt washers 88.

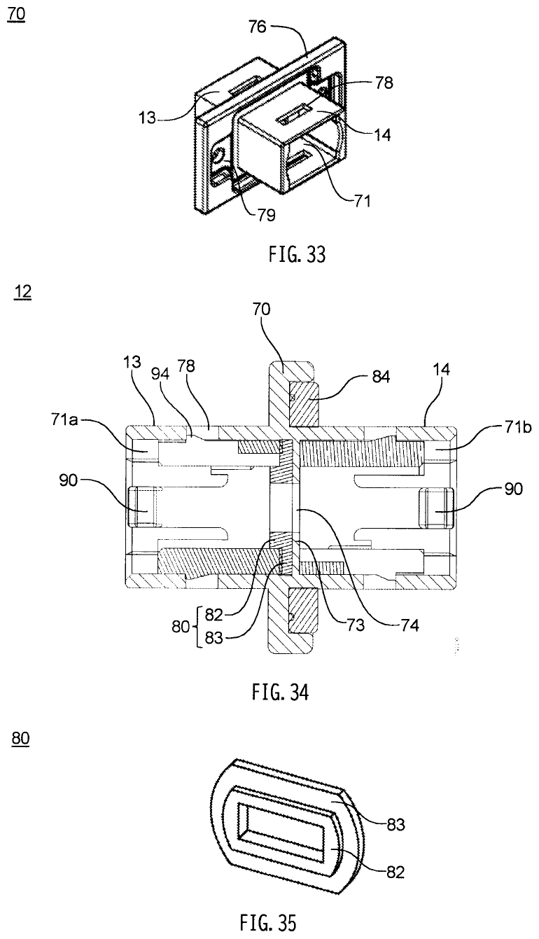

In FIG. 33, the first end portion 13 is separated from the second end portion 14 by a blocking wall 76. The blocking wall 76 may include a receiving groove 79 to receive the second sealing member 84. Since the second sealing member 84 is disposed between the first end portion 13 and the second end portion 14, the second sealing member 84 is located between the adapter housing 70 and the outer surface of the device when the optical fiber adapter 12 is mounted to the device, preventing water from entering the interior of the device through openings in the device casing.

In FIG. 34, the optical fiber adapter 12 includes a channel 71 extending from the first end portion 13 to the second end portion 14 to establish an optical communication channel inside the adapter 12. A partition wall 73 is provided in the channel 71 to divide the channel 71 into a first passage 71a and a second passage 71b. The first passage 71a is located at the first end portion 13, and the second passage 71b is located at the second end portion 14. A partition wall through-hole 74 is disposed in the middle of the partition wall 73 so that the first passage 71a communicates with the second passage 71b. The first sealing member 80 is disposed in at least one of the first passage 71a and the second passage 71b and is disposed against the partition wall 73. The first sealing member 80 is abutted against the partition wall 73 by the hook element 90, thereby preventing moisture or humidity from entering the passage 71a or 71b. The optical fiber adapter 12 includes hook elements 90 disposed in the first passage 71a and the second passage 71b, respectively.

As shown in FIG. 35, the thickness of the middle portion 82 of the first sealing member 80 is greater than that of the edge portion 83 thereof, such that the first sealing member 80 is configured in the form of steps. When the first sealing member 80 is installed in the first passage 71a, one side of the first sealing member 80 faces the partition wall 73.

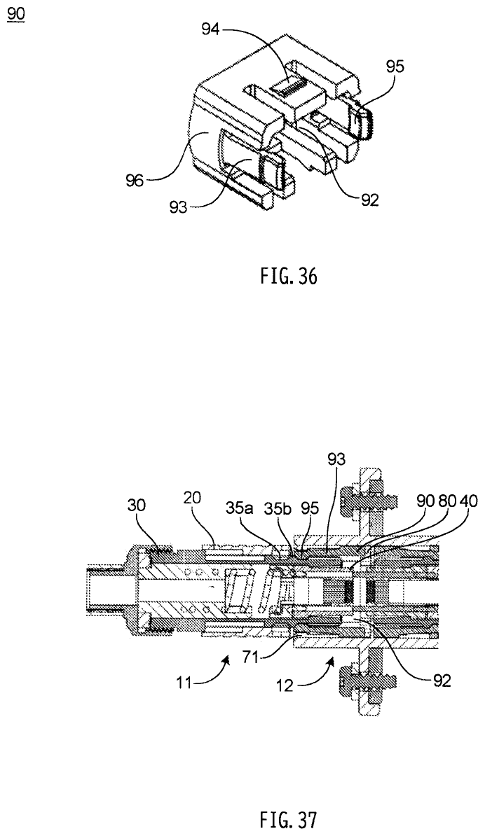

As shown in FIG. 36, the hook element 90 includes a hook element body 96 (which may also be referred to as a hook body 96) and side arm(s) 93. The hook element body 96 includes an accommodating space 92 for accommodating the connector. The side arm(s) 93 extends from the hook element body 96. The end portion of the side arm(s) 93 is provided with a hook portion 95 for locking with the optical fiber connector. Preferably, the hook element 90 includes two symmetrically arranged side arms 93.

The adapter housing 70 includes a clamping portion, and the hook element 90 includes a locking portion. When the hook element 90 is installed in the passage 71a or 71b, the clamping portion cooperates with the locking portion, such that the hook element 90 is locked in the passage 71a or 71b and is connected to the adapter housing 70 while the hook element 90 presses the first sealing member 80 against the partition wall 73. Specifically, the adapter housing 70 includes a matching window 78, and the hook element 90 includes a locking portion 94. As shown in FIG. 34, when the hook element 90 is installed in the first passage 71a, the locking portion 94 is locked in the matching window 78, such that the hook element 90 is snap-fitted with the adapter housing 70.

### Eighth Preferred Embodiment

The eighth preferred embodiment of the present application provides an optical fiber connection system 300, which is shown in FIGS. 26 and 37 to 39. In this embodiment, the axial direction is a direction parallel to the direction in which the optical fiber extends, and is also referred to as the front-back direction. The cross-section is a section perpendicular to the axial direction.

Wherein the optical fiber connector 11 according to the sixth preferred embodiment and the optical fiber adapter 12 of the seventh preferred embodiment of the present application constitute the optical fiber connection system 300 according to the present application.

As shown in FIG. 37, the optical fiber connector 11 is inserted into the optical fiber adapter 12, that is, the first passage 71a, and the hook portion 95 of the hook element 90 contacts the inclined portion 35b of the inner housing 30. The outer housing 20 contacts the hook element 90, and as the optical fiber connector 11 moves toward the optical fiber adapter 12, the outer housing 20 is blocked by the hook element 90 to move in a direction opposite to the insertion direction.

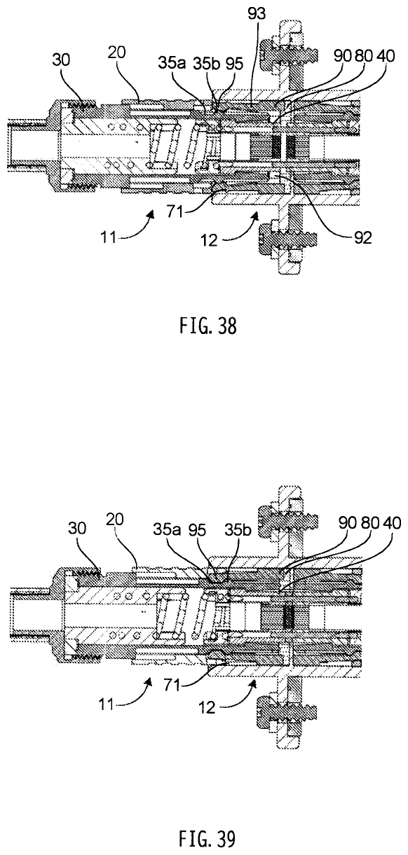

In FIG. 38, as the hook portion 95 moves along the slope of the inclined portion 35b, accompanied by further insertion of the optical fiber connector 11, the outer housing 20 continues to be pushed in the direction opposite to the insertion direction, that is, the outer housing 20 is pushed toward the second position (the rear end 39 of the inner housing 30) to expose the locking groove 35a.

With further insertion of the optical fiber connector 11, the hook portion 95 moves through the inclined portion 35b to be received in the locking groove 35a while the inner housing 30 presses against the first sealing member 80. The end portion of the inner housing 30 may be chamfered to facilitate the contact with the first sealing member 80 and press against the middle portion 82 such that the optical fiber connector 11 enters the position in the optical fiber adapter 12, as shown in FIG. 39. When the optical fiber connector 11 stops moving, the outer housing 20 returns to the first position under the action of the flexible arm(s) 25, thus covering the side arm(s) 93. A portion of the outer housing 20 that enters into the optical fiber adapter 12 is located outside the hook element 90.

For the purpose of illustration, the optical fiber connector in the present application is a MPO (Multi-fiber Push On) connector, and the optical fiber adapter is a MPO adapter that mates with it accordingly. Those skilled in the art would understand that the technical solution of the present application can also be applied to other types of connectors.

Unless otherwise defined, the technical and scientific terms used herein have the same meanings as commonly understood by those skilled in the technical field of the present application. The terms used herein are only for describing specific implementation purposes, and are not intended to limit the present application. Feature(s) described in one embodiment herein may be applied to another embodiment alone or in combination with other feature(s), unless the feature(s) is not applicable in the other embodiment or otherwise stated.

The present application has been described through the above-mentioned embodiments, but it should be understood that the above-mentioned embodiments are only for the purpose of illustration and description, and are not intended to limit the embodiments. More variations and modifications can be made according to the teachings of the present application, and these variations and modifications fall within the protection scope claimed by the present application.

1. An optical fiber connector for mating with an optical fiber adapter, comprising:
an inner housing comprising a front end portion, a rear end portion, and an open space extending from the front end portion to the rear end portion, the front end portion being used to be inserted into the optical fiber adapter, and the rear end portion being provided with a first engaging portion;
a ferrule assembly disposed in the open space of the inner housing and used to accommodate optical fibers, and at least partially exposed from the front end portion;
a rear body connected to the rear end portion of the inner housing and having a first matching portion configured to snap fit with the first engaging portion;
an elastic member disposed in the open space and held between the ferrule assembly and the rear body; and
a sealing component held between the inner housing and the rear body.

2. The optical fiber connector of claim 1, wherein the rear body comprises an insertion portion, an exposed portion and an optical fiber channel extending from the exposed portion to the insertion portion, the insertion portion is at least partially inserted into the rear end portion in a forward direction, the optical fiber channel communicates with the open space, and the elastic member and the sealing component both abut against the insertion portion.

3. The optical fiber connector of claim 2, wherein,
the first matching portion has a first end and a second end opposite to the first end, the first end is connected to the insertion portion, and the second end is spaced apart from an outer surface of the insertion portion, the first matching portion has a protruding portion protruding outward and arranged at the second end;
an opening is disposed at the rear end portion of the inner housing and forms the first engaging portion; and
wherein the first matching portion can be deformed to make the second end close to the outer surface of the insertion portion to allow the protruding portion to enter the opening to be snap-fitted within the opening.

4. The optical fiber connector of claim 2, wherein,
a surface of the insertion portion facing the forward direction is provided with an accommodating portion for accommodating the elastic member; and
the elastic member is configured to press against the rear body such that the rear body tends to move in a backward direction to allow the first engaging portion to secure tightly with the first matching portion.

5. The optical fiber connector of claim 2, wherein the rear body further comprises a transition portion connected between the insertion portion and the exposed portion and attached to the rear end portion of the inner housing, the transition portion has a key portion extending toward the forward direction, and the key portion is spaced apart from the insertion portion such that the rear end portion of the inner housing is sandwiched between the key portion and the insertion portion.

6. The optical fiber connector of claim 5, wherein a side surface of the key portion is provided with a concave-convex structure, the key portion is used to be inserted into a keyway opening in the optical fiber adapter, and the concave-convex structure can form a matching connection with an additional concave-convex structure on a side wall of the keyway opening.

7. The optical fiber connector of claim 1, wherein,
the optical fiber connector comprises an outer housing comprising a frame portion and an operating portion connected to the frame portion, the operating portion is used to be held and operated by an operator, and the frame portion is provided with a second matching portion;
the inner housing further has a middle portion connected between the front end portion and the rear end portion, and the middle portion has a second engaging portion; and
wherein the outer housing is sheathed on the inner housing in a backward direction, and the second engaging portion can snap-fit with the second matching portion.

8. The optical fiber connector of claim 7, wherein the second engaging portion is configured as a projection protruding from an outer surface of the inner housing, and the second matching portion is configured as an end portion of the frame portion along the forward direction, wherein the frame portion is located behind the projection when the second engaging portion is snap-fitted with the second matching portion.

9. The optical fiber connector of claim 8, wherein the rear end portion of the inner housing is provided with a blocking portion, the frame portion of the outer housing has an elastic portion abutting against the blocking portion, such that the outer housing tends to move toward the forward direction to make the second engaging portion secure tightly with the second matching portion.

10. An optical fiber adapter comprising two oppositely disposed receiving portions and a partition wall arranged between the two receiving portions, the receiving portions comprising a first receiving portion for receiving a first optical fiber connector, and the first receiving portion comprising:
a first housing having a first insertion end, a first mating end, and a first passage extending from the first insertion end to the first mating end, the first insertion end of the first housing being provided with a keyway opening for receiving a key portion of the first optical fiber connector;
a first sealing member disposed at the first mating end and attached to the partition wall; and
a hook element disposed in the first housing and configured to press the first sealing member to the partition wall, and the hook element having an accommodating space for accommodating at least part of the optical fiber connector.

11. The optical fiber adapter of claim 10, wherein an additional concave-convex structure is provided on the periphery of the keyway opening to be able to match with a concave-convex structure on the key portion of the first optical fiber connector.

12. The optical fiber adapter of claim 10, wherein the two oppositely disposed receiving portions both are configured as the first receiving portions, the two first sealing members of the two first receiving portions are attached to the partition wall opposite to each other, and the two first passages of the two first receiving portions are communicated at the partition wall.

13. The optical fiber adapter of claim 10, wherein the receiving portions comprise a second receiving portion configured to receive a second optical fiber connector and arranged oppositely relative to the first receiving portion, and the second receiving portion comprises:
a second housing having a second insertion end, a second mating end, and a second passage extending from the second insertion end to the second mating end and communicating with the first passage at the partition wall; and
another hook element disposed in the second housing and abutting against the partition wall, having the accommodating space for accommodating at least part of the optical fiber connector.

14. The optical fiber adapter of claim 13, wherein the optical fiber adapter further comprises:
a mounting portion arranged around the first receiving portion at a junction of the first receiving portion and the second receiving portion and provided with a receiving groove on a side surface facing the second receiving portion; and
a second sealing member disposed around the second receiving portion and attached within the receiving groove.

15. The optical fiber adapter of claim 10, wherein the hook element comprises:
a hook body inside which the accommodating space is formed;
a side arm connected to the hook body and configured to lock an optical fiber connector when the optical fiber connector is inserted into the optical fiber adapter;
a locking portion disposed on an outer surface of the hook body and configured to enable the hook element to be connected to a housing of the receiving portion;
a polarity portion disposed on an inner surface of the hook body and used to receive a polarity key on the optical fiber connector;
wherein an inner surface of the hook element is configured to closely fit an outer side surface of the front end portion of the inner housing of the first optical fiber connector.

16. The optical fiber adapter of claim 15, wherein the respective polarity portions of the two hook elements of the two receiving portions are oppositely oriented.

17. An optical fiber connection system, comprising:
at least one first optical fiber connector configured as the optical fiber connector of claim 1; and
the optical fiber adapter of claim 10;
wherein the first optical fiber connector is insertable into a first receiving portion of the optical fiber adapter and is capable of pressing a first sealing member located in a first housing of the first receiving portion for a watertight sealing.

18. The optical fiber connection system of claim 17. wherein a first insertion end of the first housing of the optical fiber adapter surrounds a middle portion of an inner housing of the first optical fiber connector.

19-20. (canceled)
